(19) United States
(12) Patent Application Publication
(10) Pub. No.: US 2005/0019607 A1
(43) Pub. Date: Jan. 27, 2005

(54) OLED device with mixed emissive layer

(76) Inventors: Franky So, San Jose, CA (US); Georg Wittmann, Herzogenaurach (DE)

Correspondence Address: Siemens Corporation;Attn: Elsa Keller, Legal Administrator, Intellectual Property Department, 186 Wood Avenue South, Iselin, NJ, 08830, US

(21) Appl. No.: 10/854,050

(22) Filed: May 26, 2004

Related U.S. Application Data
(60) Provisional application No. 60/484,001, filed on Jun. 30, 2003.

(51) Int. Cl. H05B 33/14

(52) U.S. Cl. 428/690; 428/917; 313/504; 313/506; 427/66

(57) ABSTRACT

One embodiment of this invention pertains to an organic light emitting diode (“OLED”) device that includes a substrate, an anode on the substrate, a hole transport layer on the anode, an emissive polymer layer on the hole transport layer, and a cathode on the emissive polymer layer. The emissive polymer layer is comprised of a blend of organic emissive polymers and a hole transport material. The hole transport material can be either polymers or small molecules.

### CROSS-REFERENCE TO RELATED APPLICATIONS

This application claims benefit of U.S. Provisional Patent Application having the Application No. 60/484,001 filed on Jun. 30, 2003 and entitled “OLED with Mixed Emissive Layer.”

### BACKGROUND OF THE INVENTION

An organic light emitting diode (“OLED”) display typically includes, in sequence: (1) a transparent anode (e.g., the anode can be comprised of indium tin oxide (“ITO”)); (2) a hole transporting layer (“HTL”); (3) an electron transporting and light emitting layer (“emissive layer”); and (4) a cathode. When a forward bias is applied, holes are injected from the anode into the HTL, and the electrons are injected from the cathode into the emissive layer. Both carriers are then transported towards the opposite electrode and allowed to recombine with each other in the display, the location of which is called the recombination zone.

In this display device, the holes have to travel a longer distance to reach the emissive polymer layer compared to the electrons. In addition, there is an additional barrier for hole injection at the interface between the HTL and the emissive polymer layer that further suppresses the injection of holes into the emissive layer. Also, the position of the recombination zone is determined in part by the relative rates of motion (mobilities) of the two charge carriers (e.g., electrons and holes) within the emissive layer. If the electron mobility is greater than the hole mobility (this is typically the case in the OLED display), then the recombination zone is localized in the region close to the “HTL/emissive polymer layer” interface. These factors together often result in the recombination zone being close to the “HTL/emissive polymer layer” interface.

As FIG. 1 shows, in a typical prior art OLED display, the majority of the recombinations and decays occur near the “HTL/emissive polymer layer” interface and a significant number of recombinations and decays occur in the HTL. Recombinations and decays that occur close to the “HTL/emissive polymer layer” interface cause many electrons to leak into the HTL resulting in degradation of this layer and thus decreasing the lifetime of the display. In addition, as electrons leak into the HTL, the HTL breaks down and injects fewer holes into the emissive layer. As the number of holes injected into the emissive polymer layer decreases, the recombination zone moves deeper into the HTL resulting in the device efficiency decreasing. The efficiency decreases as the number of recombinations and exciton decays occurring in the HTL increases. The efficiency decreases since recombinations and decays in the HTL do not emit light.

As shown in FIG. 1, in the typical OLED display, the number of holes in the emissive polymer layer is much less than the number of electrons. This is due, in part, to the large energy barrier for hole injection existing at the interface between the HTL and the emissive polymer layer. The energy barrier for hole injection is the difference between the highest occupied molecular orbital (“HOMO”) energy levels of two adjacent layers (e.g., here, the two adjacent layers are the HTL and the emissive polymer layer). The number of holes decreases as the holes travel deeper into the emissive polymer layer causing the number of recombinations to also decrease since there are fewer holes with which the electrons can combine. The number of recombinations decreases to the point where there are almost no recombinations occurring in the middle portion of the emissive layer.

Because of the adverse effects on OLED device efficiency and lifetime when the recombination zone is near the “HTL/emissive polymer layer” interface, there is a need for an OLED device in which the recombination zone is sufficiently far from that interface.

### SUMMARY

One embodiment of this invention pertains to an OLED display that includes a substrate, an anode on the substrate, a hole transport layer on the anode, an emissive polymer layer on the hole transport layer, and a cathode on the emissive polymer layer. The emissive polymer layer is comprised of a blend of organic emissive polymers and a hole transport material. The hole transport material can be either polymers or small molecules.

### BRIEF DESCRIPTION OF THE DRAWINGS

FIG. 1 shows the recombination distribution in a typical prior art OLED display.

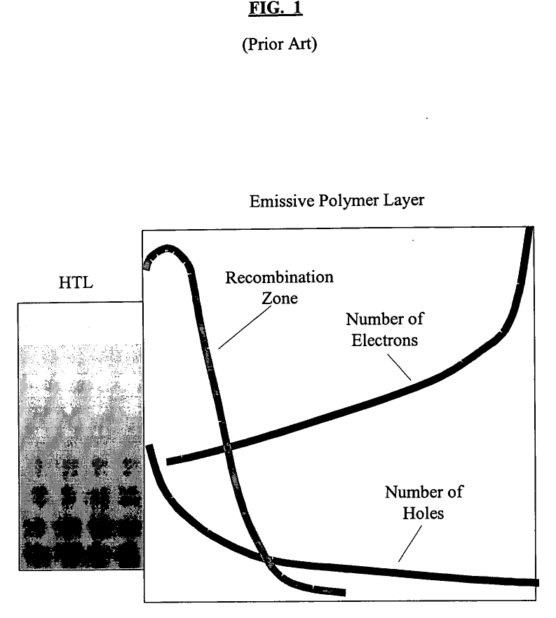

FIG. 2 shows a cross-sectional view of an embodiment of the OLED display according to the present invention.

FIG. 3 shows the recombination distribution in an embodiment of the OLED display according to the present invention.

### DETAILED DESCRIPTION

For improved performance, the OLED device should be designed so that the recombination zone is positioned in the emissive polymer layer sufficiently far from the cathode so that quenching is minimized, and sufficiently far from the “HTL/emissive polymer layer” interface so that lifetime and/or efficiency is improved. The position of the recombination zone can be controlled, in part, by controlling the mobility of the charge carriers in the emissive polymer layer, and also by controlling the ease with which charge carriers can inject from an adjacent layer (e.g., the HTL) into the emissive polymer layer.

Since the electron mobility in the emissive polymer layer is typically greater than the hole mobility, the hole mobility in the emissive polymer layer can be increased so that the recombination zone is located in the middle portion of the emissive polymer layer. By increasing the hole mobility, the holes will travel deeper into the emissive polymer layer within a specific time period and thus the recombinations between the holes and electrons will occur deeper in the emissive polymer layer, rather than near the “HTL/emissive polymer layer” interface.

Typically, the number of holes in the emissive polymer layer is much less than the number of electrons. Allowing holes to more easily inject into the emissive polymer layer increases the number of holes in that layer. The ease of hole injection into the emissive layer can be adjusted such that there is an almost equal number of holes and electrons in the middle portion of the emissive polymer layer so that the recombination zone is positioned sufficiently far from the cathode so that quenching is minimized, and sufficiently far from the “HTL/emissive polymer layer” interface so that lifetime and/or efficiency is improved. In addition, if there is a better balance between the number of holes and electrons in the emissive polymer layer, then the probability of recombinations increases and so fewer electrons “escape” the emissive polymer layer and leak into the HTL. If there are fewer number of electrons reaching the HTL, then the degradation of the HTL is reduced thus increasing the display lifetime.

In order to increase the hole mobility in the emissive polymer layer and also increase the number of holes injected into the emissive polymer layer, in one embodiment of the invention, the emissive polymer layer is comprised of a blend of organic emissive polymers and an added hole transport material. The added hole transport material can be either polymers or small molecules.

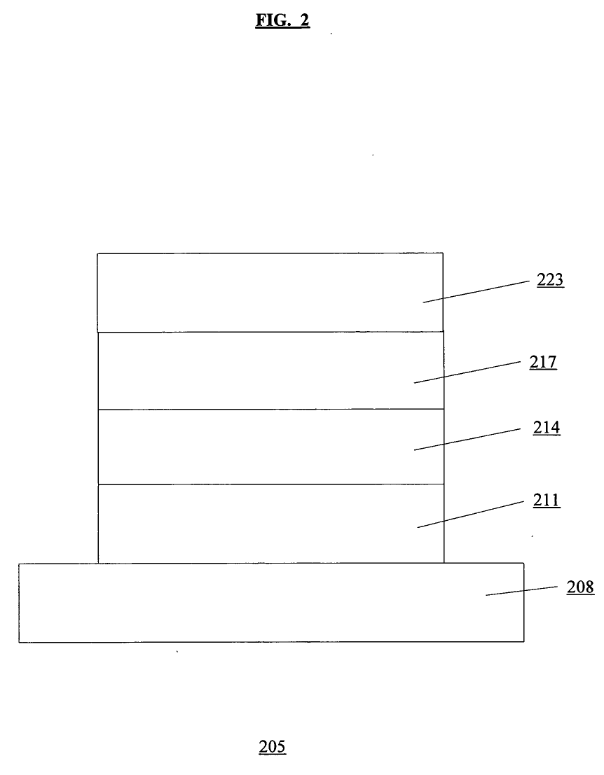

FIG. 2 shows a cross-sectional view of a first embodiment of an OLED device 205 according to the present invention. The OLED device 205 can be, for example, a pixel within an OLED display, or an element within an OLED light source used for general purpose lighting. In FIG. 2, an anode 211 is on a substrate 208. As used within the specification and the claims, the term “on” includes when there is direct physical contact between the two parts (e.g., layers) and when there is indirect contact between the two parts because they are separated by one or more intervening parts. A HTL 214 is on the anode 211. An emissive polymer layer 217 is on the HTL 214. The emissive polymer layer 217 is comprised of a blend of organic emissive polymers and the added hole transport material. A cathode 223 is on the emissive polymer layer 217. Some of these layers are described in greater detail below.

Substrate 208:

The substrate 208 can be any material, which can support the layers on it. The substrate 208 can be transparent or opaque (e.g., the opaque substrate is used in top-emitting devices). By modifying or filtering the wavelength of light which can pass through the substrate 208, the color of light emitted by the device can be changed. Preferable substrate materials include glass, quartz, silicon, stainless steel, and plastic; preferably, the substrate 208 is comprised of thin, flexible glass. The preferred thickness of the substrate 208 depends on the material used and on the application of the device. The substrate 208 can be in the form of a sheet or continuous film. The continuous film is used, for example, for roll-to-roll manufacturing processes which are particularly suited for plastic, metal, and metallized plastic foils.

Anode 211:

The anode 211 is comprised of a high work function material; for example, the anode 211 can have a work function greater than about 4.5 eV. Typical anode materials include metals (such as platinum, gold, palladium, nickel, indium, and the like); metal oxides (such as tin oxide, indium tin oxide (“ITO”), and the like); graphite; doped inorganic semiconductors (such as silicon, germanium, gallium arsenide, and the like); and highly doped conducting polymers (such as polyaniline, polypyrrole, polythiophene, and the like).

The anode 211 can be transparent, semi-transparent, or opaque to the wavelength of light generated within the device. The thickness of the anode 211 is from about 10 nm to about 1000 nm, and preferably, from about 50 nm to about 200 nm.

The anode 211 can typically be fabricated using any of the techniques known in the art for deposition of thin films, including, for example, vacuum evaporation, sputtering, electron beam deposition, or chemical vapor deposition.

HTL 214:

The HTL 214 has a much higher hole mobility than electron mobility and is used to effectively transport holes from the anode 211. The HTL 214 is comprised of, for example, PEDOT:PSS, or polyaniline (“PANI”).

The HTL 214 functions as: (1) a buffer to provide a good bond to the substrate; and/or (2) a hole injection layer to promote hole injection; and /or (3) a hole transport layer to promote hole transport.

The HTL 214 can be deposited using selective deposition techniques or nonselective deposition techniques. Examples of selective deposition techniques include, for example, ink-jet printing, flex printing, and screen printing. Examples of nonselective deposition techniques include, for example, spin coating, dip coating, web coating, and spray coating.

Emissive Polymer Layer 217:

The emissive polymer layer 217 is on the HTL 214. The emissive polymer layer 217 is comprised of a blend of organic emissive polymers and the added hole transport material. The hole transport material can be either polymers or small molecules.

If the hole transport material is polymers, then these polymers are added into a solution that includes the organic emissive polymers and a solvent. These components are blended and the resulting blend is deposited on the HTL 214 and allowed to dry to form the emissive polymer layer 217. The blend can be deposited using techniques such as, for example, spin coating, ink-jet printing, or dip coating. Examples of polymer hole transport material that can be added to the solution include: (1) polymers containing aromatic amine structures in the main chain or the side chain; (2) polyanilines and derivatives thereof; (3) polythiophenes and derivatives thereof; (4) polypyrroles and derivatives thereof; (5) poly (phenylene vinylenes) and derivatives thereof; (6) poly (thienylene vinylenes) and derivatives thereof; (7) polyquinolines and derivatives thereof; (8) polyquinoxalines and derivatives thereof; or (9) combinations thereof.

Alternatively, if the hole transport material is small molecules, then these small molecules can be added into the solution that includes the organic emissive polymers and the solvent. These components are blended and the resulting blend is deposited on the HTL 214 and allowed to dry to form the emissive polymer layer 217. The blend can be deposited using techniques such as, for example, spin coating, ink-jet printing, or dip coating. Alternatively, the emissive polymer layer comprised of the blend of organic emissive polymers and small molecule hole transport material can be formed by, first, depositing the small molecule hole transport material on the HTL 214. The small molecule hole transport material can be deposited using techniques such as, for example, vacuum evaporation or sputtering. Then, a solution that includes the organic emissive polymers and a solvent is deposited on the small molecule hole transport material. The solution can be deposited using techniques such as, for example, spin coating, ink-jet printing, or dip coating. The deposited organic emissive solution dissolves the small molecule hole transport material and blends with it and upon this blend drying, forms the emissive polymer layer 217 that is comprised of the blend of the organic emissive polymers and the added hole transport material. An example of small molecule hole transport material includes small molecule amine such as, for example, arylamine or starburst amine.

The addition of the hole transport material increases the hole mobility in the resulting emissive polymer layer 217. Depending on, for example, how much hole transport material is used, the properties of the hole transport material, and the properties of the organic emissive polymers, the hole mobility in the emissive polymer layer 217 can be controlled so that the recombination zone is positioned sufficiently far from the “HTL/emissive polymer layer” interface to minimize HTL degradation and sufficiently far from the cathode to minimize quenching of the emitted light. The hole mobility in the organic emissive polymer layer can be increased so that, for example, the hole mobility is at least ten times greater than the electron mobility, and preferably, the hole mobility is at least 100 times greater than the electron mobility. By adding the hole transport material, the hole mobility in the resulting emissive polymer layer 217 can be easily increased without having to create a new material.

The addition of the hole transport material increases the number of holes that are injected from an adjacent layer (e.g., the HTL 214) into the emissive polymer layer 217. The properties of the hole transport material, how much hole transport material is used, and the properties of the organic emissive polymers can be adjusted so that the number of holes injected into the emissive polymer layer 217 is increased such that the recombination zone is positioned sufficiently far from the “HTL/emissive polymer layer” interface to minimize HTL degradation and sufficiently far from the cathode to minimize quenching of the emitted light. Adding the hole transport material to the organic emissive polymers increases the number of holes injected into the emissive polymer layer 217 because, in part, the added material broadens the ionization potential (“IP”) range of the resulting emissive polymer layer 217 so that some of the IP values of the emissive polymer layer 217 are brought closer to the IP values of the HTL 214 and thus more HOMO energy states with lower energy barriers exist that the holes can more easily overcome increasing the likelihood that more holes are injected into the emissive polymer layer 217. In addition or alternatively, the addition of the hole transport material adds intermediate HOMO energy states that are between the highest IP value of the HTL 214 and the lowest IP value of the emissive polymer layer 217. The added intermediate states allow a larger number of holes to inject into the emissive polymer layer 217 at any one time.

The emissive polymer layer 217 includes organic emissive polymers. Preferably, the organic emissive polymers are fully or partially conjugated polymers. For example, suitable organic emissive polymers include one or more of the following in any combination: poly(p-phenylenevinylene) (“PPV”), poly(2-methoxy-5(2′-ethyl)hexyloxyphenylenevinylene) (“MEH-PPV”), one or more PPV-derivatives (e.g. di-alkoxy or di-alkyl derivatives), polyfluorenes and/or co-polymers incorporating polyfluorene segments, PPVs and related co-polymers, poly(2,7-(9,9-di-n-octylfluorene)-(1,4-phenylene-((4-secbutylphenyl)imino)-1,4-phenylene) (“TFB”), poly(2,7-(9,9-di-n-octylfluorene)-(1,4-phenylene-((4-methylphenyl)imino)-1,4-phenylene-((4-methylphenyl)imino)-1,4-phenylene)) (“PFM”), poly(2,7-(9,9-di-n-octylfluorene)-(1,4-phenylene-((4-methoxyphenyl)imino)-1,4-phenylene)) (“PFMO”), poly (2,7-(9,9-di-n-octylfluorene) (“F8”), (2,7-(9,9-di-n-octylfluorene)-3,6-Benzothiadiazole) (“F8BT”), or poly(9,9-dioctylfluorene).

Preferred organic emissive polymers include LUMATION Light Emitting Polymers (“LEPs”) that emit green, red, blue, or white light or their families, copolymers, derivatives, or mixtures thereof; the LUMATION LEPs are available from The Dow Chemical Company, Midland, Mich. Other polymers include polyspirofluorene-like polymers available from Covion Organic Semiconductors GmbH, Frankfurt, Germany. Other blue emitting polymer are, for example, poly (9,9-dialkyl fluorene), poly(9,9-diaryl fluorene), polyphenylenes, poly(2,5-dialkyl phenylene), copolymers of these materials, or copolymers with monomers comprising arylamine units.

Such organic emissive polymers are well known in the art and are described in, for example, Bredas, J. -L., Silbey, R., eds., Conjugated Polymers, Kluwer Academic Press, Dordrecht (1991) which is incorporated by reference herein in its entirety.

The thickness of the emissive polymer layer 217 is from about 5 nm to about 500 nm, and preferably, from about 20 nm to about 100 nm.

Cathode 223:

The cathode 223 is a conductive layer which serves as an electron-injecting layer and which comprises a material with a low work function. The cathode is typically a multilayer structure that includes, for example, a thin charge injection layer and a thick conductive layer. The charge injection layer has a lower work function than the conductive layer. The charge injection layer can be comprised of, for example, calcium or barium or mixtures thereof. The conductive layer can be comprised of, for example, aluminum, silver, magnesium, or mixtures thereof. Alternatively, the cathode can be a three layer structure where, for example, the charge injection layer is on a layer of lithium fluoride.

The cathode 223 can be opaque, transparent, or semi-transparent to the wavelength of light generated within the device. The thickness of the cathode 223 is from about 10 nm to about 1000 nm, preferably from about 50 nm to about 500 nm, and more preferably, from about 100 nm to about 300 nm.

The cathode 223 can typically be fabricated using any of the techniques known in the art for deposition of thin films, including, for example, vacuum evaporation, sputtering, electron beam deposition, or chemical vapor deposition.

Alternatively, in another embodiment of the OLED device, the cathode layer, rather than the anode layer, is formed on the substrate. In this embodiment, the emissive polymer layer is formed on the cathode layer. The HTL is formed on the first emissive polymer layer, and the anode is formed on the HTL. This resulting device represents, for example, a top-emitting OLED device.

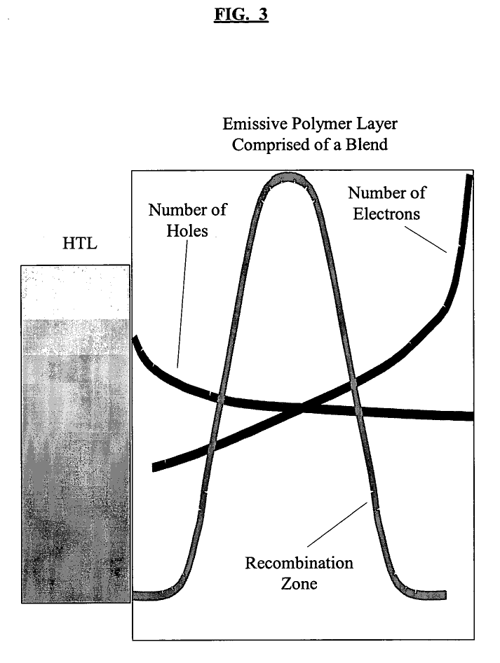

FIG. 3 shows the recombination distribution in an embodiment of the OLED display according to the present invention. As shown in FIG. 3, the emissive polymer layer comprised of the blend of organic emissive polymers and the added hole transport material has increased hole mobility so that the recombination zone occurs sufficiently far from the “HTL/emissive polymer layer” interface so as to minimize degradation of the HTL 214 and occurs sufficiently far from the cathode so that quenching of the emitted light is minimized. Preferably, the recombination zone occurs entirely in the emissive polymer layer 217. As shown in FIG. 3, the vast majority of recombinations and decays occur in the middle portion of the emissive polymer layer.

The OLED display described earlier can be used within displays in applications such as, for example, computer displays, information displays in vehicles, television monitors, telephones, printers, and illuminated signs.

As any person of ordinary skill in the art of electronic device fabrication will recognize from the description, figures, and examples that modifications and changes can be made to the embodiments of the invention without departing from the scope of the invention defined by the following claims.

1. An organic light emitting diode (“OLED”) device, comprising:
a substrate;
an anode on said substrate;
a hole transport layer on said anode;
an emissive polymer layer on said hole transport layer; and
a cathode on said emissive polymer layer,
wherein said emissive polymer layer is comprised of a blend of a plurality of organic emissive polymers and a hole transport material, and wherein said hole transport material at least one of: (1) increases hole mobility in said emissive polymer layer, and (2) increases hole injection into said emissive polymer layer.

2. The OLED device of claim 1 wherein at least one of: (1) hole mobility in said emissive polymer layer is increased and (2) hole injection into said emissive polymer layer is increased such that a recombination zone is positioned sufficiently far from said cathode so that quenching is minimized, and sufficiently far from a “hole transport layer/emissive polymer layer” interface so that at least one of lifetime and efficiency is improved.

3. The OLED device of claim 1 wherein at least one of: (1) hole mobility in said emissive polymer layer is increased and (2) hole injection into said emissive polymer layer is increased such that a majority of recombinations and decays occur in a middle portion of said emissive polymer layer.

4. The OLED device of claim 1 wherein said hole mobility in said emissive polymer layer is increased such that said hole mobility is at least ten times greater than an electron mobility in said emissive polymer layer.

5. The OLED device of claim 4 wherein said hole mobility is increased such that said hole mobility is at least 100 times greater than said electron mobility in said emissive polymer layer.

6. The OLED device of claim 1 wherein
said hole transport material is polymers or small molecules.

7. The OLED device of claim 6 wherein
said polymers are: (1) polymers containing aromatic amine structures in the main chain or the side chain; (2) polyanilines and derivatives thereof; (3) polythiophenes and derivatives thereof; (4) polypyrroles and derivatives thereof; (5) poly (phenylene vinylenes) and derivatives thereof; (6) poly (thienylene vinylenes) and derivatives thereof; (7) polyquinolines and derivatives thereof; (8) polyquinoxalines and derivatives thereof; or (9) combinations thereof; and
said small molecules are small molecule amines.

8. The OLED device of claim 6 wherein said hole transport material is polymers and said emissive polymer layer is formed by:
blending said polymer hole transport material and a solution that includes organic emissive polymers and a solvent to produce a blend;
depositing said blend on said hole transport layer; and
allowing said blend to dry to form said emissive polymer layer.

9. The OLED device of claim 6 wherein said hole transport material is small molecules and said emissive polymer layer is formed by:
blending said small molecule hole transport material and a solution that includes organic emissive polymers and a solvent to produce a blend;
depositing said blend on said hole transport layer; and
allowing said blend to dry to form said emissive polymer layer.

10. The OLED device of claim 6 wherein said hole transport material is small molecules and said emissive polymer layer is formed by:
depositing said small molecule hole transport material on said hole transport layer;
depositing a solution on said small molecule hole transport material, said solution includes organic emissive polymers and a solvent, said solution dissolves said small molecule hole transport material and blends with said small molecule hole transport material to produce a blend; and
allowing said blend to dry to form said emissive polymer layer.

11. The OLED device of claim 1 wherein said OLED device is a pixel of an OLED display or said OLED device is an element of an OLED light source used for general purpose lighting.

12. A method to fabricate an OLED device, comprising:
forming an anode on a substrate;
forming a hole transport layer on said anode;
blending hole transport material and a solution to produce a blend;
depositing said blend on said hole transport layer; and
allowing said blend to dry to form an emissive polymer layer on said hole transport layer,
wherein said hole transport material at least one of: (1) increases hole mobility in said emissive polymer layer, and (2) increases hole injection into said emissive polymer layer.

13. The method of claim 12 further comprising
forming a cathode on said emissive polymer layer.

14. The method of claim 13 wherein at least one of: (1) hole mobility in said emissive polymer layer is increased and (2) hole injection into said emissive polymer layer is increased such that a recombination zone is positioned sufficiently far from said cathode so that quenching is minimized, and sufficiently far from a “hole transport layer/emissive polymer layer” interface so that at least one of lifetime and efficiency is improved.

15. The method of claim 12 wherein said hole mobility in said emissive polymer layer is increased such that said hole mobility is at least ten times greater than an electron mobility in said emissive polymer layer.

16. The method of claim 15 wherein said hole mobility is increased such that said hole mobility is at least 100 times greater than said electron mobility in said emissive polymer layer.

17. The method of claim 12 wherein said hole transport material is polymers or small molecules.

18. The method of claim 17 wherein said polymers are: (1) polymers containing aromatic amine structures in the main chain or the side chain; (2) polyanilines and derivatives thereof; (3) polythiophenes and derivatives thereof; (4) polypyrroles and derivatives thereof; (5) poly (phenylene vinylenes) and derivatives thereof; (6) poly (thienylene vinylenes) and derivatives thereof; (7) polyquinolines and derivatives thereof; (8) polyquinoxalines and derivatives thereof; or (9) combinations thereof; and
said small molecules are small molecule amines.

19. The method of claim 12 wherein said blend is deposited using any one of the following techniques: spin coating, ink-jet printing, or dip coating.

20. A pixel of an OLED display fabricated according to the method recited in claim 12.

21. A method to fabricate an OLED device, comprising:
forming an anode on a substrate;
forming a hole transport layer on said anode;
depositing a hole transport material on said hole transport layer, wherein said hole transport material is small molecules;
depositing a solution on said small molecule hole transport material, said solution dissolves said small molecule hole transport material and blends with said small molecule hole transport material to produce a blend; and
allowing said blend to dry to form an emissive polymer layer on said hole transport layer,
wherein said small molecule hole transport material at least one of: (1) increase hole mobility in said emissive polymer layer, and (2) increases hole injection into said emissive polymer layer.

22. The method of claim 21 further comprising
forming a cathode on said emissive polymer layer.

23. The method of claim 22 wherein at least one of: (1) hole mobility in said emissive polymer layer is increased and (2) hole injection into said emissive polymer layer is increased such that a recombination zone is positioned sufficiently far from said cathode so that quenching is minimized, and sufficiently far from a “hole transport layer/emissive polymer layer” interface so that at least one of lifetime and efficiency is improved.

24. The method of claim 21 wherein said hole mobility is increased such that said hole mobility is at least 100 times greater than an electron mobility in said emissive polymer layer.

25. The method of claim 21 wherein
said hole transport material is deposited using any one of the following techniques: vacuum evaporation, or sputtering; and
said solution is deposited using any one of the following techniques: spin coating, ink-jet printing, or dip coating.

26. A pixel of an OLED display fabricated according to the method recited in claim 21.
